(19) United States
(12) Patent Application Publication
(10) Pub. No.: US 2026/0367297 A1
(43) Pub. Date: Nov. 19, 2026

(54) MULTIFUNCTION MODULAR OPTICAL DEVICE

(71) Applicant: VIAVI Solutions Inc., Chandler, AZ (US)

(72) Inventors: Johannes P. SEYDEL, Petaluma, CA (US); Jaroslaw ZIEBA, Santa Rosa, CA (US)

(21) Appl. No.: 19/672,153

(22) Filed: May 8, 2026

Related U.S. Application Data
(60) Provisional application No. 63/806,313, filed on May 15, 2025.

(51) Int. Cl. G02B 5/20; G02B 27/00

(52) U.S. Cl. CPC G02B 5/20; G02B 27/0006

(57) ABSTRACT

In some implementations, a multifunction modular optical device includes a plurality of discrete functional modules disposed in a vertical or horizontal configuration on the multifunction modular optical device, wherein each functional module, of the plurality of discrete functional modules, is associated with a corresponding discrete function for the multifunction modular optical device.

### CROSS-REFERENCE TO RELATED APPLICATION

This Patent Application claims priority to U.S. Provisional Patent Application No. 63/806,313, filed on May 15, 2025, and entitled “MULTIFUNCTION MODULAR OPTICAL HORIZONTALLY AND VERTICALLY INTEGRATED DEVICE.” The disclosure of the prior Application is considered part of and is incorporated by reference into this Patent Application.

### BACKGROUND

Optical devices are used in a wide range of technological applications, such as imaging systems, telecommunications systems, and scientific instrumentation. Optical devices can incorporate components, such as lenses, filters, or sensors, among other examples, to manipulate and detect light for various purposes. The integration of optical elements enables precise control over light transmission, reflection, and absorption, which is essential for achieving desired performance characteristics in many advanced systems. Multifunction modular optical devices can be used to selectively transmit specific wavelengths while blocking other wavelengths, thereby enhancing the functionality of optical systems.

### SUMMARY

In some implementations, a multifunction modular optical device includes a plurality of discrete functional modules disposed in a vertical or horizontal configuration on the multifunction modular optical device, wherein each functional module, of the plurality of discrete functional modules, is associated with a corresponding discrete function for the multifunction modular optical device.

In some implementations, a method includes integrating, using a pick-and-place technique, a first set of active or passive modules, of a plurality of active or passive modules, onto an optical device to perform a corresponding first set of functions; and integrating, using a patterning technique, a second set of active or passive modules, of the plurality of active or passive modules, onto the optical device to perform a corresponding second set of functions, wherein the plurality of active or passive modules includes at least one of a vertical stack of two or more modules or a horizontal stack of two or more modules.

In some implementations, a multifunction modular optical device assembly comprising: a target substrate; and a multifunction optical module disposed on the target substrate, the multifunction optical module comprising a plurality of discrete optical elements arranged in a pattern, wherein the pattern includes the plurality of discrete optical elements arranged laterally and horizontally in a multi-layer configuration.

### BRIEF DESCRIPTION OF THE DRAWINGS

FIG. 1 is a diagram of an example implementation associated with a multifunction modular optical device.

FIG. 2 is a diagram of an example implementation associated with a multifunction modular optical device.

FIG. 3 is a diagram of an example implementation associated with a multifunction modular optical device.

FIG. 4 is a diagram of an example implementation associated with a multifunction modular optical device.

FIGS. 5A and 5B are diagrams of example implementations associated with a multifunction modular optical device.

FIG. 6 is a flowchart of an example process associated with manufacturing a multifunction modular optical device.

### DETAILED DESCRIPTION

The following detailed description of example implementations refers to the accompanying drawings. The same reference numbers in different drawings may identify the same or similar elements.

Optical devices are used in a variety of applications, including telecommunications, data transmission, sensing, and imaging. Optical devices can have multiple functional elements, such as filters, couplers, waveguides, and protective layers. The presence of multiple functional elements may help an optical device achieve desired optical, electrical, and mechanical properties. However, optical devices may be constructed as monolithic or singular-function components, which can limit performance, flexibility, and adaptability to different use cases.

Some approaches to integrating multiple functionalities into an optical device involve complex fabrication processes, such as vacuum deposition or high-temperature processing, which may impose constraints on the choice of substrate materials, device geometries, or integration environments. Such approaches can also lead to challenges in achieving precise alignment, index matching, and reliable bonding between different functional layers or modules within the device.

Furthermore, the integration of active and passive components with differing mechanical, chemical, or thermal properties can introduce additional challenges, such as stress concentration, thermal mismatch, or degradation of optical performance. The lack of modularity and adaptability in existing optical device architectures can hinder the development of high-performance, multifunctional optical systems tailored to specific applications or operating environments.

Some implementations described herein provide a multifunctional modular optical device that integrates active and passive modules with optical, electrical, mechanical, and chemical functions through both horizontal and vertical (H/V) integration techniques. For example, an optical device can include optical modules, such as light couplers, optical filters, stress compensators, crosstalk controllers, or protective layers, among other examples, which can be combined using micro- and nano-scale pick-and-place and three-dimensional patterning technologies. Such an integration process allows the optical device to be assembled without restrictions on target material, size, geometry, processing temperature, or environment. Additionally, such an integration process obviates a need for vacuum deposition on the target substrate. Modules may be pre-assembled or integrated directly onto a final interface, and can include features such as index matching, polarization control, electrical conductivity, stress relief, or environmental protection.

In this way, techniques described herein enable the creation of optical devices with multi-functional capabilities and modular construction, thereby allowing for precise tuning of optical, electrical, and mechanical properties and robust integration of diverse functionalities at both micro- and nano-scale levels. The modular approach provides enhanced compatibility with a wide range of substrates and environments, and supports the integration of optical modules without the need for restrictive processing conditions, such as vacuum deposition or high-temperature treatments. In this way, techniques described herein may reduce material waste and processing complexity, thereby conserving manufacturing resources, material resources, and energy consumption during fabrication and integration.

As a result, the solution improves the technical performance and adaptability of optical systems by supporting advanced functionalities while simplifying manufacturing and integration processes. In this way, the modular device architecture may conserve processing resources, memory resources (for example, by reducing the need for complex device design iterations), and/or material resources, and enables more efficient deployment in diverse optical, photonic, and sensing applications.

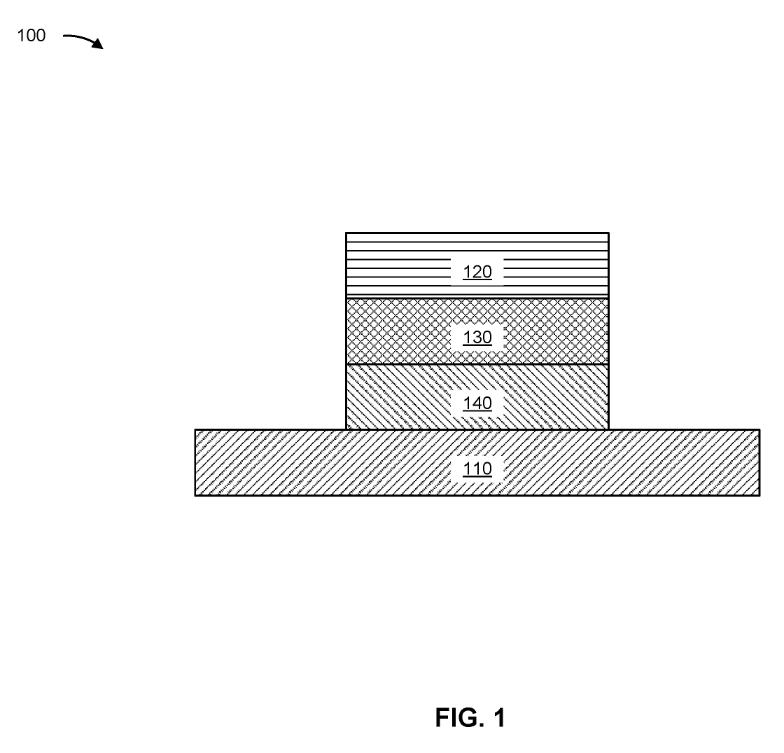

FIG. 1 is a diagram of an example implementation associated with a multifunction modular optical device As shown in FIG. 1, a multifunction modular optical device 100 includes an optical device 110 and a set of optical modules, such as a first optical module 120, a second optical module 130, and a third optical module 140.

In some implementations, the multifunction modular optical device 100 includes the optical device 110 as a target device or target onto which a plurality of discrete optical modules is disposed in a vertical stack. As shown in FIG. 1, the third optical module 140 is disposed on an upper surface of the optical device 110, the second optical module 130 is disposed on the third optical module 140, and the first optical module 120 is disposed on the second optical module 130 such that the first optical module 120 defines an upper interface of the vertical stack. In some implementations, each of the first optical module 120, the second optical module 130, and the third optical module 140 is an active or passive optical module associated with a corresponding discrete function for the optical device 110. For example, the optical device 110 can include a photonic chip, an image sensor, a detector substrate, a waveguide device, a glass substrate, a polymer substrate, a semiconductor substrate, or another optical device configured to receive, guide, filter, or detect light in a telecommunications system, an imaging system, a sensing system, or a scientific instrument, among other examples. A passive optical module may include an optical module that provides a selected optical function without power, actuation, or other control, such as a fixed filter, coupler, waveguide, diffuser, lens, or index-matching layer. In contrast, an active optical module may include an optical module whose optical behavior is controlled, tuned, switched, or otherwise modified by an applied input, such as an electrical signal, light, heat, or another control stimulus, such as in a tunable filter, modulator, or controllable metasurface.

In some implementations, the first optical module 120 receives incident light at the upper interface of the multifunction modular optical device 100 and provides a first optical function, such as by conditioning the incident light before the incident light reaches the second optical module 130, the third optical module 140, and the optical device 110. For example, the first optical module 120 can be a light coupling module that directs light into an underlying optical region of the optical device 110 and reduces insertion loss at the upper interface of the multifunction modular optical device 100. In this case, the first optical module 120 can be index matched to an adjacent top interface, such as air, an encapsulant, a cover element, or another optical layer, to improve optical transmission into the multifunction modular optical device 100. Additionally, or alternatively, the first optical module 120 can include a light-guiding diffusor structure that redistributes light over a selected angular range, or the first optical module 120 can include a metasurface optical structure that imposes a selected phase response, diffraction response, polarization response, or beam-shaping response on the incident light, among other examples.

In some implementations, the second optical module 130 is disposed below the first optical module 120 and provides a second function, such as by providing discrete optical filtering for the optical device 110. For example, the second optical module 130 can be an optical filter module that transmits one or more selected wavelength bands and blocks or attenuates one or more other wavelength bands. In this case, the second optical module 130 can include a multilayer interference filter, a bandpass filter, a notch filter, a long-pass filter, a short-pass filter, an absorptive filter, or one or more tunable optical filters. The second optical module 130 can be matched with the first optical module 120 such that the first optical module 120 establishes an angular, spatial, or polarization condition for incoming light and the second optical module 130 applies a spectral selection function to the conditioned light.

In some implementations, the third optical module 140 is disposed between the second optical module 130 and the optical device 110 and provides a third function, such as by providing a mechanical interface function and an optical interface function for the multifunction modular optical device 100. For example, the third optical module 140 can be a stress compensating module that reduces stress concentration at a surface of the optical device 110, accommodates thermal expansion mismatch between overlying modules and the optical device 110, or protects the optical device 110 from deformation, cracking, or optical misalignment during manufacture or operation, among other examples. In this case, the third optical module 140 can also match (e.g., to within a threshold percentage) a refractive index of the surface of the optical device 110 to reduce reflection losses between the third optical module 140 and the optical device 110.

Additionally, or alternatively, the third optical module 140 can include or be associated with a chemically activated adhesion interface disposed between adjacent optical modules. For example, a chemically activated adhesion interface can be disposed between the third optical module 140 and the optical device 110 or between the third optical module 140 and the second optical module 130, and the chemically activated adhesion interface can form a chemical bond at a surface to fix a placement position of the third optical module 140 by crosslinking or curing an adhesion layer after alignment. In some implementations, the third optical module 140 may mechanically decouple the optical device 110 from an optical stack (e.g., the first and second optical modules 120 and 130), thereby providing stress-management for the optical device 110 and/or the optical stack.

In some implementations, one or more optical modules 120, 130, or 140 of the multifunction modular optical device 100 may incorporate a refractive index gradient. The refractive index gradient can vary continuously or discretely across a thickness or lateral extent of the module, thereby enabling advanced optical performance such as tailored transmission, reduced reflection, improved beam shaping, or enhanced coupling efficiency. For example, a filter optical module may have a refractive index that transitions from a higher value on one interface to a lower value on the opposite interface, optimizing spectral selectivity and minimizing insertion loss. The ability to incorporate an index gradient within a module allows for precise tuning of optical properties and provides additional flexibility in device design.

In some implementations, the multifunction modular optical device 100 may include a polarization optical module disposed in the vertical stack or in a horizontal stack. A polarization optical module is configured to control, filter, or modify the polarization state of incident light, such as converting unpolarized light to polarized light, rotating the polarization axis, or selectively passing certain polarization components. The polarization optical module may include materials or structures such as birefringent layers, polarizing films, or metasurfaces with polarization-selective features. Integration of a polarization module within the multifunction modular optical device 100 enables enhanced control over optical signal characteristics and supports applications having polarization-sensitive detection or processing.

In some implementations, multiple instances of the vertical stack formed by the optical modules 120, 130, and 140 can be arranged laterally across the optical device 110, such that the multifunction modular optical device 100 provides a plurality of discrete optical filters arranged in a horizontal pattern and in a multi-layer configuration. In some implementations, the multifunction modular optical device 100 can include one or more additional optical modules. For example, the multifunction modular optical device 100 can include an optical module that is laterally integrated relative to the first optical module 120, the second optical module 130, and the third optical module 140 to control lateral optical crosstalk between neighboring optical regions or neighboring devices on the optical device 110. Additionally, or alternatively, the multifunction modular optical device 100 can include a protective module disposed over the first optical module 120. In this case, the protective module can provide environmental protection, mechanical protection, or chemical protection, among other examples, for the first optical module 120, the second optical module 130, and the third optical module 140

In some implementations, the multifunction modular optical device 100 distributes different functions across the first optical module 120, the second optical module 130, and the third optical module 140 rather than combining the different functions into a monolithic structure on the optical device 110. For example, the first optical module 120 can provide a light coupling function, a light-guiding diffusor function, or a metasurface function, the second optical module 130 can provide a spectral filtering function, and the third optical module 140 can provide a stress compensation function, an index-matching function, and/or an adhesion function at an interface with the optical device 110. In some implementations, the multifunction modular optical device 100 also includes laterally arranged optical modules and therefore provides horizontal and vertical integration of optical, electrical, mechanical, and chemical functions in a common device architecture. In this way, the multifunction modular optical device 100 improves optical performance, reduces stress-induced degradation, supports modular customization of the optical device 110, and simplifies integration relative to monolithic optical device architectures.

As indicated above, FIG. 1 is provided as an example. Other examples may differ from what is described with regard to FIG. 1.

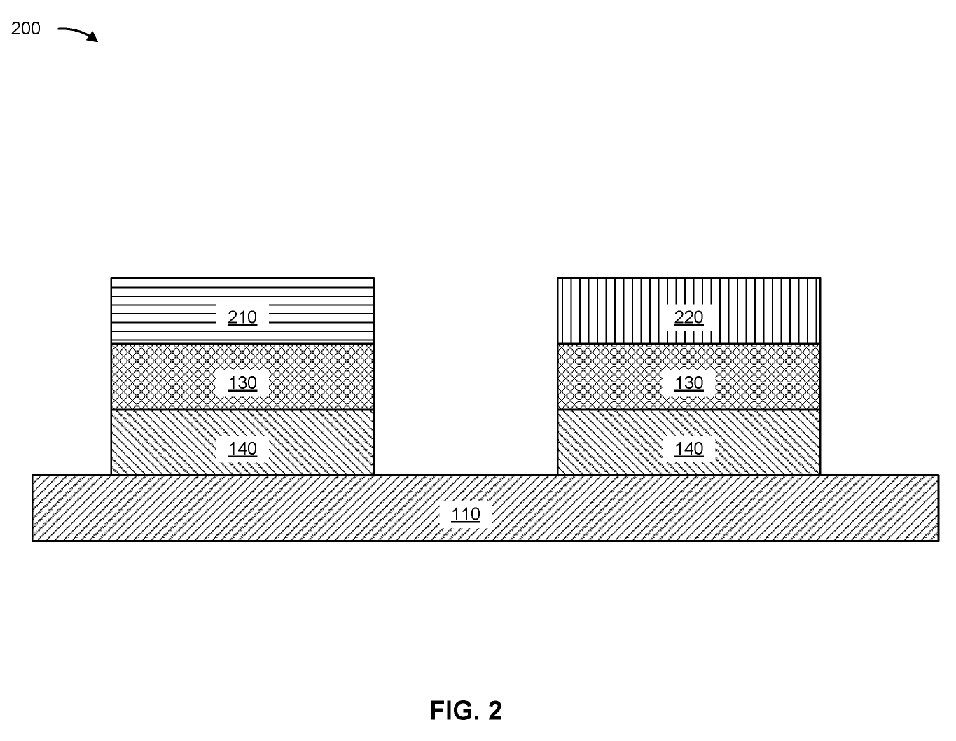

FIG. 2 is a diagram of an example implementation associated with a multifunction modular optical device. As shown in FIG. 2, the multifunction modular optical device 200 includes a plurality of laterally separated vertical stacks disposed on the optical device 110, such that the multifunction modular optical device 200 provides horizontal and vertical integration on the optical device 110. A first vertical stack includes the optical module 210 disposed over the second optical module 130 and the third optical module 140, and a second vertical stack includes the optical module 220 disposed over a corresponding second optical module 130 and a corresponding third optical module 140. In some implementations, the optical module 210 and the optical module 220 are aligned with different optical regions, channels, pixels, waveguides, or devices of the optical device 110. For example, the optical module 210 can include a first type of optical filter (e.g., a light-guiding diffusor module that redistributes or guides incident light toward a first optical region of the optical device 110), and the optical module 220 can include a second type of optical filter (e.g., a metasurface optical module that imposes a selected phase response, diffraction response, polarization response, or beam-shaping response on light directed toward a second optical region of the optical device 110). During operation, the optical module 210 and the optical module 220 can therefore provide different upper-interface optical functions at different lateral locations while the corresponding second optical module 130 and third optical module 140 provide underlying filtering and interface functions, among other examples. In this way, the multifunction modular optical device 200 can define a pattern of discrete optical structures arranged laterally across the optical device 110 in a common multi-layer configuration and can tailor optical performance for respective optical regions without changing the underlying optical device 110.

As indicated above, FIG. 2 is provided as an example. Other examples may differ from what is described with regard to FIG. 2.

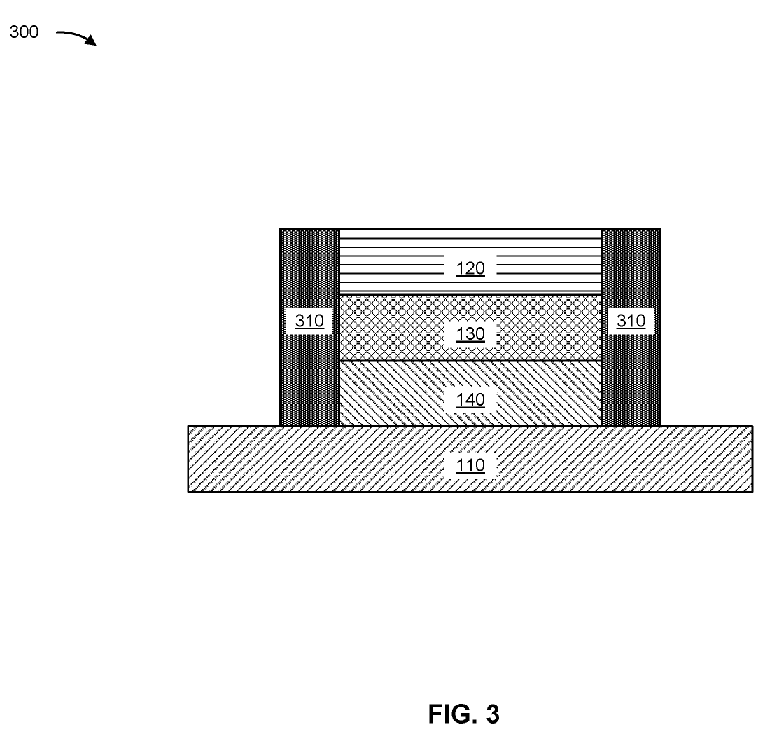

FIG. 3 is a diagram of an example implementation associated with a multifunction modular optical device. As shown in FIG. 3, the multifunction modular optical device 300 may include the first optical module 120, the second optical module 130, and the third optical module 140 arranged on the optical device 110, and may include one or more optical modules 310 laterally integrated with the vertical stack formed by the optical modules 120, 130, and 140. For example, the multifunction modular optical device 300 includes two optical modules 310 disposed on opposite lateral sides of the vertical stack, such that the optical modules 310 extend from the optical device 110 along the sides of the optical modules 120, 130, and 140.

In some implementations, the optical modules 310 are configured for lateral optical crosstalk control between the vertical stack and one or more neighboring optical regions, channels, pixels, waveguides, or devices of the optical device 110. In this way, the multifunction modular optical device 300 avoids crosstalk when multiple vertical stacks are arranged laterally across the optical device 110 and stray light from one vertical stack could otherwise reach another vertical stack. For example, the optical modules 310 can form optical isolation walls. In this case, the optical modules 310 may be formed of an optically absorptive material, a reflective material, a scattering material, or another material selected to control laterally propagating light. In this way, the optical modules 310 can absorb, reflect, scatter, or otherwise redirect stray light to reduce light leakage from the vertical stack and to reduce entry of stray light from adjacent regions. The optical modules 310 can thereby improve channel isolation and preserve optical functions provided by the optical modules 120, 130, and 140.

Additionally, or alternatively, the optical modules 310 can provide a lateral light coupling function, a structural support function, or an alignment function for placement of the vertical stack on the optical device 110. For example, the optical modules 310 can laterally redirect, confine, or shape light traveling into or out of the vertical stack to improve optical coupling with a neighboring optical region of the optical device 110. In some implementations, the optical modules 310 can also reinforce side portions of the vertical stack to reduce shifting, tilting, or deformation of the optical modules 120, 130, and 140 during placement or operation. Additionally, or alternatively, the optical modules 310 can define side alignment features, registration surfaces, or positioning boundaries that assist in locating or disposing the optical modules 120, 130, and 140 at selected positions on the optical device 110.

In this way, the multifunction modular optical device 300 provides a horizontally and vertically integrated architecture in which the optical modules 310 add a lateral control function to the stacked functions provided by the optical modules 120, 130, and 140.

As indicated above, FIG. 3 is provided as an example. Other examples may differ from what is described with regard to FIG. 3.

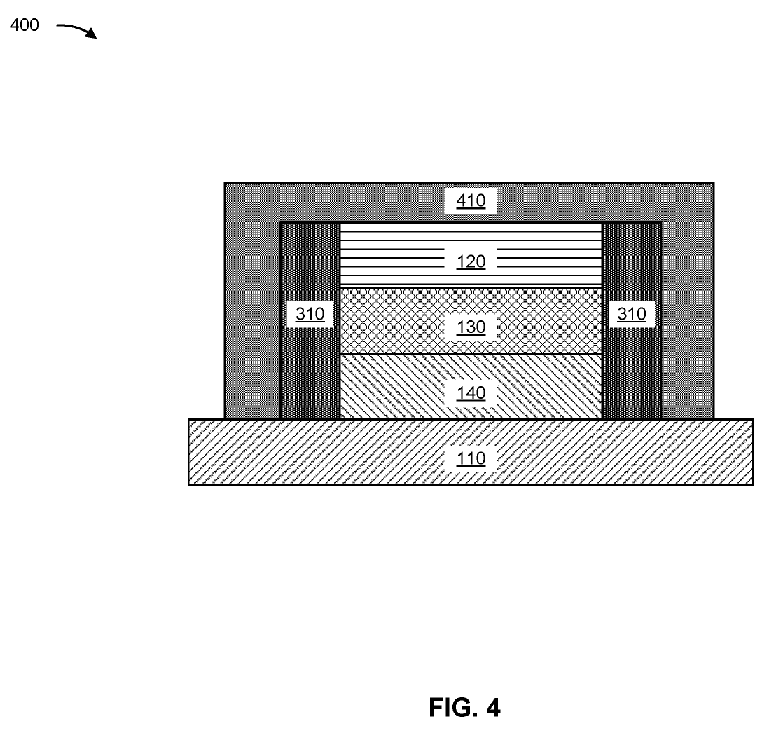

FIG. 4 is a diagram of an example implementation associated with a multifunction modular optical device. As shown in FIG. 4, an multifunction modular optical device 400 includes the optical device 110, the first optical module 120, the second optical module 130, the third optical module 140, and the optical modules 310, and includes an optical module 410 disposed on the optical device 110 and around the optical modules 120, 130, and 310. For example, the optical module 410 extends from the optical device 110 along outer sides of the optical modules 310 and across an upper side of the first optical module 120, such that the optical module 410 covers the optical modules 120, 130, 140, and 310.

In some implementations, the optical module 410 is a protective module that provides an outer interface for the multifunction modular optical device 400 and protects the optical modules 120, 130, 140, and 310 from moisture, particulates, chemicals, abrasion, impact, or other environmental conditions. For example, the optical module 410 can be a cap, an encapsulation layer, a coating, a molded layer, or another cover structure that retains relative positions of the optical modules 120, 130, 140, and 310 after placement on the optical device 110 and reduces shifting or damage during manufacture, handling, or operation. Additionally, or alternatively, the optical module 410 can include an optically transmissive material and/or an index-matching material over the first optical module 120 to reduce reflection loss for light entering the multifunction modular optical device 400, or the optical module 410 can include an electrically conductive layer material to provide static charge protection. In some implementations, the optical module 410 and the optical modules 310 are configured, together to provide a protected region around the vertical stack (e.g., the optical modules 120, 130, and 140) to add environmental, mechanical, chemical, and/or electrical functionality to the horizontal and vertical integration provided by the optical filter array assembly 400. For example, the optical module 410 may include an indium, tin oxide, graphene, or metal material, among other examples.

As indicated above, FIG. 4 is provided as an example. Other examples may differ from what is described with regard to FIG. 4.

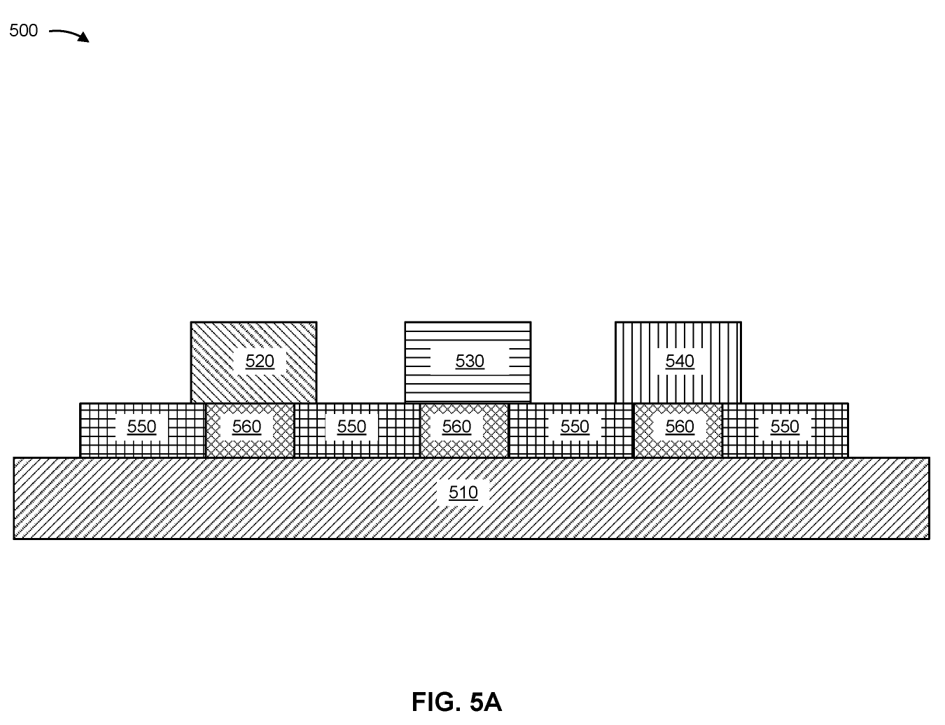

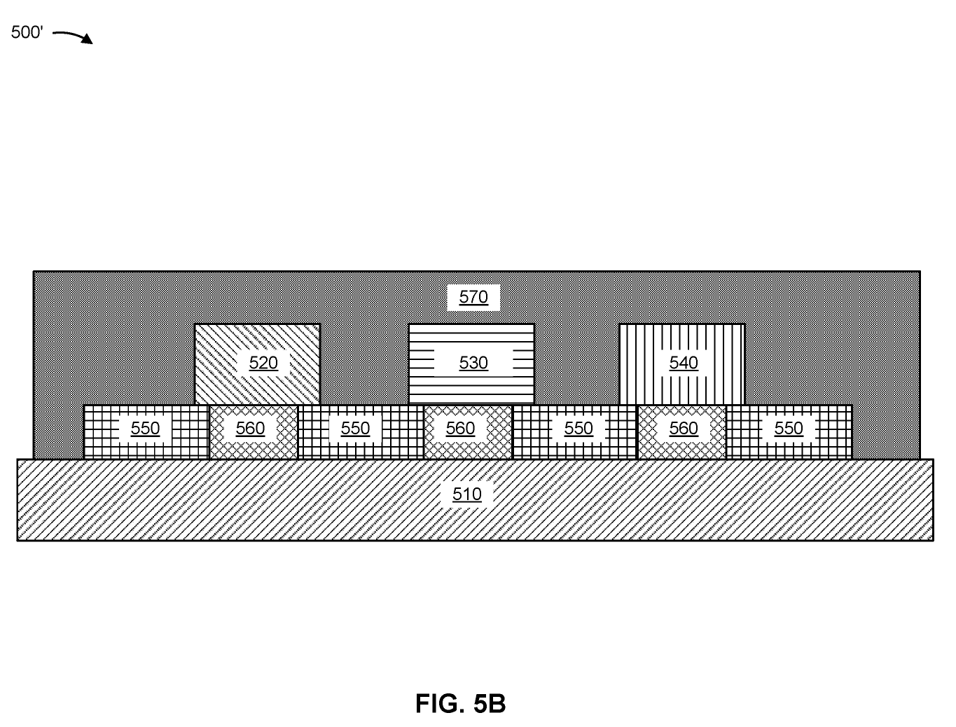

FIGS. 5A and 5B are diagrams of example implementations associated with an optical filter array assembly. As shown in FIG. 5A, a multifunction modular optical device 500 includes an optical device 510 and a plurality of laterally arranged optical modules disposed on the optical device 510. For example, the multifunction modular optical device 500 includes an optical module 520, an optical module 530, and an optical module 540 disposed at different lateral positions on the optical device 510. In some implementations, a layer of alternating optical modules 550 and 560 are disposed on the optical device 510, with the optical modules 520, 530, and 540 being disposed on top of the layer of alternating optical modules 550 and 560.

In some implementations, the optical module 520, the optical module 530, and the optical module 540 are selected to provide different respective optical functions for different optical regions of the optical device 510. For example, the optical module 520, the optical module 530, and the optical module 540 can define different optical filter structures configured to pass different wavelength bands, different light coupling structures configured for different angular responses, or different metasurface or diffusor structures configured for different phase, polarization, or beam-shaping responses. In some implementations, the optical modules 560 can provide local interface functions for the optical module 520, the optical module 530, and the optical module 540, such as adhesion, index matching, stress compensation, alignment, or local support, while the optical modules 550 can provide lateral separation between neighboring optical regions to reduce optical crosstalk and define spacing between laterally adjacent optical modules. For example, the optical modules 550 and the optical modules 560 can be formed on the optical device 510 before placement of the optical module 520, the optical module 530, and the optical module 540, such that different upper optical modules can be selected and integrated at different lateral positions without changing the optical device 510.

In some implementations, FIG. 5B shows a multifunction modular optical device 500' that includes the optical device 510, the optical module 520, the optical module 530, the optical module 540, the optical modules 550, and the optical modules 560, and further includes an optical module 570 disposed around the optical module 520, the optical module 530, the optical module 540, the optical modules 550, and the optical modules 560. In some implementations, the optical module 570 is a protective module that spans multiple laterally arranged optical modules and provides a shared outer interface for the multifunction modular optical device 500'. For example, the optical module 570 can be an encapsulation layer, cap, cover, or coating that protects the laterally arranged optical modules from moisture, contamination, abrasion, impact, or electrostatic charge while retaining relative positions of the laterally arranged optical modules after placement on the optical device 510. Additionally, or alternatively, the optical module 570 can include an optically transmissive material, an index-matching material, or an electrically conductive material such that the optical module 570 adds optical, protective, and/or electrical functionality across multiple laterally arranged optical regions at the same time.

As indicated above, FIGS. 5A and 5B are provided as examples. Other examples may differ from what is described with regard to FIGS. 5A and 5B.

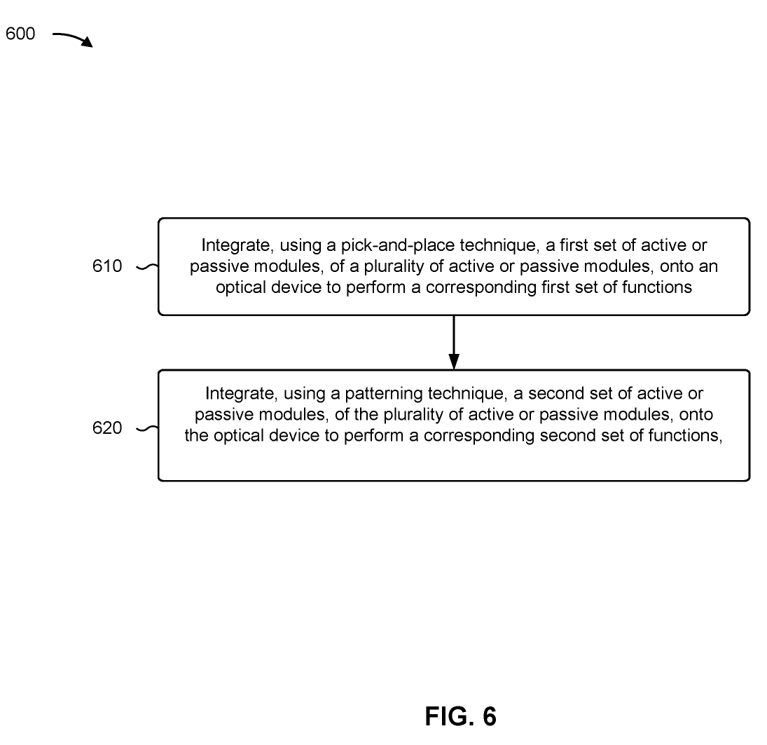

FIG. 6 is a flowchart of an example process 600 associated with manufacturing a multifunction modular optical device. One or more process blocks of FIG. 6 are performed by a device (e.g., a pick-and-place device, a patterning device, a sputter deposition device, or another type of device).

In some implementations, the device performs process 600 at a wafer level, a die level, a panel level, a package level, or a device level. Additionally, or alternatively, the device performs process 600 during fabrication of an optical device, after fabrication of the optical device, or as part of a post-fabrication customization or retrofit process. In some implementations, the device identifies one or more target regions on the optical device, such as pixels, waveguides, detector regions, coupling regions, or other optical regions, and selects corresponding module types from a set of available active optical modules and passive optical modules for placement and/or formation at the one or more target regions. For example, the device can assemble a modular arrangement that provides horizontal integration, vertical integration, or both horizontal integration and vertical integration on the optical device. In some implementations, the device includes or is associated with a vision system, an alignment subsystem, a metrology subsystem, or a controller configured to position, inspect, and process micro-scale or nano-scale optical modules relative to the optical device.

As shown in FIG. 6, process 600 includes integrating, using a pick-and-place technique, a first set of active or passive modules, of a plurality of active or passive modules, onto an optical device to perform a corresponding first set of functions (block 610). For example, the device may integrate, using a pick-and-place technique, a first set of active or passive modules, of a plurality of active or passive modules, onto an optical device to perform a corresponding first set of functions, as described above. In some implementations, the first set of active or passive modules includes pre-formed discrete optical modules that are transferred from a donor substrate, a carrier, a tray, a reel, or another source structure to the optical device. For example, the device can singulate or otherwise release individual modules or groups of modules from the donor substrate before transfer, and can place the individual modules or groups of modules at selected target regions on the optical device.

In some implementations, the device prepares a target surface of the optical device before placement by cleaning, activating, planarizing, priming, or otherwise conditioning the target surface to receive one or more modules. Additionally, or alternatively, the device can apply an adhesion-promoting material, an index-matching material, a compliant material, or another interface material at the target surface before placement of a module. In some implementations, the device uses fiducials, registration features, machine vision, optical alignment marks, mechanical stops, or other alignment techniques to align a module to a selected optical region, and can perform a coarse placement followed by a fine placement adjustment before final fixation of the module. In some implementations, the device places individual modules one at a time, places multiple modules in sequence, or places multiple modules simultaneously across multiple target regions of the optical device. For example, the first set of active or passive modules can include one or more optical modules that form at least part of a vertical stack, one or more optical modules that form at least part of a horizontal stack, or one or more optical modules that are laterally repeated across an array of optical regions on the optical device.

As further shown in FIG. 6, process 600 includes integrating, using a patterning technique, a second set of active or passive modules, of the plurality of active or passive modules, onto the optical device to perform a corresponding second set of functions (block 620). For example, the device may integrate, using a patterning technique, a second set of active or passive modules, of the plurality of active or passive modules, onto the optical device to perform a corresponding second set of functions, as described above. In some implementations, the plurality of active or passive modules includes at least one of a vertical stack of two or more modules or a horizontal stack of two or more modules.

In some implementations, the second set of active or passive modules includes one or more modules, layers, features, coatings, conductive regions, interface regions, crosstalk-control regions, protective regions, or optical structures formed after placement of one or more modules of the first set of active or passive modules. For example, the device can form one or more patterned regions between laterally adjacent modules, can form one or more interface regions below or above a placed module, or can form one or more protective or conductive structures over one or more placed modules. Additionally, or alternatively, the device can perform the patterning technique before the pick-and-place technique for one or more target regions, such that one or more patterned interface structures are formed in advance of module placement.

In some implementations, process 600 alternates between pick-and-place operations and patterning operations across different layers or different target regions, such that the optical filter array assembly is built in a hybrid manner using both transferred modules and patterned features. For example, the device can place a first module, pattern an interface or confinement structure relative to the first module, place a second module, and pattern an overlying or surrounding structure after placement of the second module. In some implementations, the device forms one or more conductive traces, pads, vias, or transparent conductive regions to control, actuate, or test one or more active optical modules after integration.

Process 600 may include additional aspects, such as any single aspect or any combination of aspects described below and/or in connection with one or more other processes described elsewhere herein.

In a first aspect, integrating the first set of active or passive modules comprises placing a filter array module onto a target surface of the optical device without performing a vacuum deposition. In some implementations, placing the filter array module onto the target surface without performing the vacuum deposition enables integration on temperature-sensitive materials, curved surfaces, heterogeneous-material structures, or other target surfaces for which vacuum-deposition-based formation on the target surface may be less suitable. For example, the filter array module can be fabricated separately from the optical device and later transferred to the target surface as a discrete module or as part of a subassembly. Additionally, or alternatively, omitting vacuum deposition on the target surface can reduce constraints associated with the material, geometry, size, thermal budget, or surrounding environment of the optical device.

In a second aspect, alone or in combination with the first aspect, the pick-and-place technique utilizes at least one of a vacuum force, a van der Waals force, a static force, a chemically controlled adhesion force, an electrically controlled adhesion force, a light controlled adhesion force, or a temperature controlled adhesion force. In some implementations, the device selects the at least one force based on a size of a module, a material of a module, a fragility of a module, a surface property of a module, an alignment tolerance, or a target placement condition. For example, the device can temporarily hold a module using one or more of the listed forces during transport and alignment and can release the module after the module reaches a selected placement position on the optical device. Additionally, or alternatively, the device can use different forces for different module types or for different stages of transfer, such as pickup, transport, fine alignment, and placement.

In a third aspect, alone or in combination with one or more of the first and second aspects, process 600 includes forming a chemical bond at a surface to fix a module placement position. In some implementations, the chemical bond is formed after alignment of a module relative to the optical device or relative to another module, such that the module is first positioned and then permanently fixed in place. For example, process 600 can include applying or activating an adhesion material, crosslinking an adhesion layer, curing an interface material, or otherwise causing a bond-forming reaction at an interface between the module and the optical device or between adjacent modules. Additionally, or alternatively, the chemical bond can be associated with a compliant layer, an index-matching layer, or a stress-relief layer at the surface to provide both mechanical fixation and optical interface functionality.

In a fourth aspect, alone or in combination with one or more of the first through third aspects, the patterning technique includes at least one of a photolithography technique, a deposition technique, an etching technique, or an ion sputtering technique. In some implementations, the patterning technique forms one or more optical layers, conductive layers, interface layers, protective layers, crosstalk-control features, alignment features, or support features relative to one or more placed modules. For example, the patterning technique can form a laterally arranged isolation wall, a conductive coating, a protective cap, a patterned optical surface, or a region configured for index matching or adhesion. Additionally, or alternatively, the patterning technique can include trimming, shaping, planarizing, or otherwise modifying a previously placed module or a previously formed layer to achieve a selected optical, mechanical, or electrical characteristic. In some implementations, the device performs one or more post-placement treatments after the patterning technique, such as curing, annealing, hardening, or testing one or more active optical modules or passive optical modules.

In a fifth aspect, alone or in combination with one or more of the first through fourth aspects, after an optical module is positioned on the optical device, the optical module is tuned using at least one of: spectral tuning, polarization tuning, adjustment of optical coupling, or adjustment or cross-talk.

In some implementations, process 600 further includes inspecting one or more placed modules or one or more patterned features. For example, the device can inspect alignment, position, rotation, bond quality, thickness, planarity, optical transmission, spectral response, polarization response, electrical continuity, or defect conditions associated with one or more modules. Additionally, or alternatively, process 600 can include reworking, removing, replacing, or repositioning a module based on an inspection result. In some implementations, the device uses modules selected from a set of available modules to improve yield and to tailor optical performance for different target regions of the optical device. In some implementations, process 600 includes forming a subassembly that includes two or more modules before placement of the subassembly onto the optical device.

In some implementations, process 600 further includes repeating one or more placement operations and one or more patterning operations across an array of target regions on the optical device to form a plurality of laterally arranged optical structures. Additionally, or alternatively, process 600 can include applying a common protective module over multiple laterally arranged modules after the multiple laterally arranged modules are integrated on the optical device. In some implementations, process 600 includes electrically testing one or more active optical modules after integration, optically testing one or more optical paths after integration, or selectively replacing one or more modules based on test results. In this way, process 600 supports modular manufacture of an optical filter array assembly using a hybrid integration approach in which different module types are placed, formed, fixed, inspected, and optionally protected on a common optical device.

Although FIG. 6 shows example blocks of process 600, in some implementations, process 600 includes additional blocks, fewer blocks, different blocks, or differently arranged blocks than those depicted in FIG. 6. Additionally, or alternatively, two or more of the blocks of process 600 may be performed in parallel.

The foregoing disclosure provides illustration and description, but is not intended to be exhaustive or to limit the implementations to the precise forms disclosed. Modifications and variations may be made in light of the above disclosure or may be acquired from practice of the implementations.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code - it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A multifunction modular optical device, comprising:
a plurality of discrete functional modules disposed in a vertical or horizontal configuration on the multifunction modular optical device ,
wherein each functional module, of the plurality of discrete functional modules, is associated with a corresponding discrete function for the multifunction modular optical device.

2. The multifunction modular optical device of claim 1, wherein the plurality of discrete functional modules further comprises:
a light coupling module disposed at an upper interface of the vertical or horizontal configuration.

3. The multifunction modular optical device of claim 2, wherein the plurality of discrete functional modules further comprises:
an optical filter module disposed below the light coupling module in the vertical or horizontal configuration.

4. The multifunction modular optical device of claim 3, wherein the plurality of discrete functional modules further comprises:
a stress compensating module disposed beneath the optical filter module in the vertical or horizontal configuration.

5. The multifunction modular optical device of claim 1, further comprising:
at least one additional optical module laterally integrated with the vertical or horizontal configuration, and wherein the at least one additional optical module is configured for lateral optical crosstalk control.

6. The multifunction modular optical device of claim 1, further comprising:
a protective module disposed over the vertical or horizontal configuration.

7. The multifunction modular optical device of claim 6, wherein the protective module further comprises:
an index-matching layer.

8. The multifunction modular optical device of claim 6, wherein the protective module further comprises:
an electrically conductive material.

9. The multifunction modular optical device of claim 1, wherein the plurality of discrete functional modules further comprises:
a metasurface optical module in the vertical or horizontal configuration.

10. The multifunction modular optical device of claim 1, wherein the plurality of discrete functional modules further comprises:
a light-guiding diffusor module as part of the vertical or horizontal configuration.

11. The multifunction modular optical device of claim 1, further comprising:
a chemically activated adhesion interface disposed between at least two adjacent functional modules of the plurality of discrete functional modules.

12. A method, comprising:
integrating, using a pick-and-place technique, a first set of active or passive modules, of a plurality of active or passive modules, onto an optical device to perform a corresponding first set of functions; and
integrating, using a patterning technique, a second set of active or passive modules, of the plurality of active or passive modules, onto the optical device to perform a corresponding second set of functions,
wherein the plurality of active or passive modules includes at least one of a vertical stack of two or more modules or a horizontal stack of two or more modules.

13. The method of claim 12, wherein integrating the first set of active or passive modules comprises:
placing a filter array module onto a target surface of the optical device without performing a vacuum deposition.

14. The method of claim 12, wherein the pick-and-place technique utilizes at least one of:
a vacuum force,
a van der Waals force,
a static force,
a chemically controlled adhesion force,
an electrically controlled adhesion force,
a light controlled adhesion force, or
a temperature controlled adhesion force.

15. The method of claim 12, further comprising:
forming a chemical bond at a surface to fix a module placement position.

16. The method of claim 12, wherein the patterning technique includes at least one of:
a photolithography technique,
a deposition technique,
an etching technique, or
an ion sputtering technique.

17. A multifunction modular optical device assembly, comprising:
a target substrate; and
a multifunction optical module disposed on the target substrate, the multifunction optical module comprising a plurality of discrete optical elements arranged in a pattern,
wherein the pattern includes the plurality of discrete optical elements arranged laterally and horizontally in a multi-layer configuration.

18. The multifunction modular optical device assembly of claim 17, further comprising a conductive layer disposed on or adjacent to the multifunction optical module, the conductive layer being configured to provide static charge protection.

19. The multifunction modular optical device assembly of claim 18, wherein the conductive layer is formed of at least one of: indium, tin oxide, graphene, or a metal.

20. The multifunction modular optical device assembly of claim 17, wherein the multifunction optical module comprises one or more tunable optical elements.
